(19) United States
(12) Patent Application Publication
(10) Pub. No.: US 2008/0126494 A1
(43) Pub. Date: May 29, 2008

(54) METHOD OF COMMUNICATION BY CODING A QUESTIONNAIRE IN AN IM APPLICATION

(75) Inventor: Nicolas Pfleger, Strasbourg (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/772,395

(22) Filed: Jul. 2, 2007

(30) Foreign Application Priority Data
Jul. 3, 2006 (FR) 0652769

(51) Int. Cl. G06F 15/16

(52) U.S. Cl. 709/206

(57) ABSTRACT

The invention relates to a method of communication between first and second terminals by means of an instant messaging (IM) application, said method comprising the following steps:
the IM application of the first terminal codes a message containing a questionnaire;
the first terminal sends said coded message to the second terminal;
the IM application of the second terminal decodes the message to generate the questionnaire corresponding to said coded message; and
the second terminal displays said questionnaire.

The invention also relates to an IM application for implementing this communication method.

### BACKGROUND OF THE INVENTION

The invention relates to a method of communication between a first terminal and a second terminal via an instant messaging (IM) application and to an IM application for implementing it.

The invention applies particularly, although not exclusively, to communication between a terminal of a call center and a terminal of a client of said call center.

A call center is a system enabling a client to communicate with services of the proprietor of said center, for example to provide on-line support for a product or a service acquired by said client.

Using a voice telephone call between the call center and the client for this purpose is known in the art. An interactive voice response (IVR) communication system can be used for this type of call, for example.

IVR technology enables interaction between a telephone and a database by pressing keys of the telephone to obtain information or to generate action. Thus an IVR call center can send a client prerecorded questions to which the client responds by pressing the corresponding key of the telephone. The responses to those questions identify the client and indicate the reason for the call, so that it can be directed to the most suitable service or operator.

It is nevertheless apparent that IVR technology does not have the user friendliness that a client is entitled to expect of a service offered by a service provider.

A web application can be used to display questions and receive responses.

This makes the process more user friendly, because the information is written rather than spoken. However, in contrast to the technologies used by call centers, that type of application is not a communication application, in particular in the sense that it is not easy for it to collect information and transfer it to an operator. Web applications are not adapted to support communication, only to display information pages.

Instant messaging (IM) applications by means of which two or more terminals can communicate using written messages are also known in the art. There are many IM applications, including MSN messenger, AOL AIM, Skype, Google Talk, Yahoo!Messenger, and Gaim. These applications typically cater for unrestricted text editing on a terminal in one or more windows, sending messages to other terminals, and displaying messages received from other terminals. Because they are user friendly, applications of this type are increasingly successful as a means of communication.

However, because there are no restrictions on the text of the messages transmitted, communication via an IM application cannot be used between a client and a call center. To identify what the client requires and guide the client to the appropriate service or operator, it is necessary for the client to give precise and unambiguous responses to the questions asked. With unrestricted text, this condition cannot be reliably satisfied by all clients, in particular because of the multiplicity of possible syntaxes and spellings that can be used in responses to the same question.

### SUMMARY OF THE INVENTION

An object of the invention is to alleviate the drawbacks of the prior art by proposing a method of communication between two terminals that is more reliable and more user friendly, in particular so that it can be used for communication between the terminal of a client and that of a call center.

To this end, the invention provides a method of communication between first and second terminals by means of an instant messaging application, said method comprising the following steps:
the instant messaging application of the first terminal codes a message containing a questionnaire;
the first terminal sends said coded message to the second terminal;
the instant messaging application of the second terminal decodes the message to generate the questionnaire corresponding to said coded message; and
the second terminal displays said questionnaire.

Thus the method of the invention combines the user friendliness of the communication of written information by means of an instant messaging application with the reliability resulting from the incorporation of a questionnaire into that information.

A second aspect of the invention provides an instant messaging application that includes means for communication of a questionnaire and the response thereto between two or more terminals. To this end, the instant messaging application includes means for coding sent messages adapted to include a questionnaire in a message and means for decoding received messages adapted to generate the questionnaire from a coded message.

### BRIEF DESCRIPTION OF THE DRAWINGS

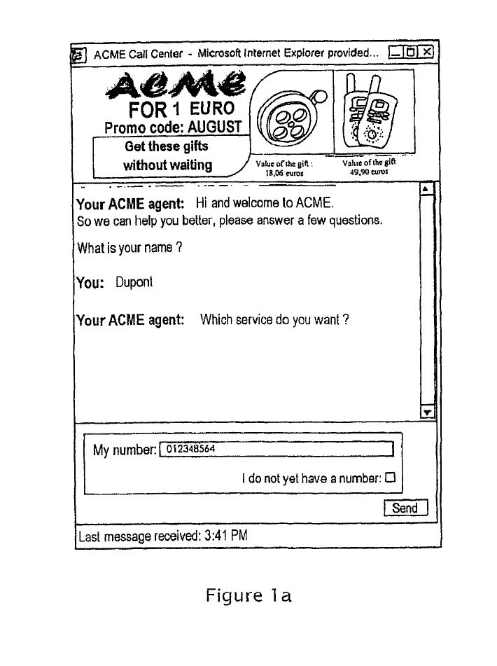

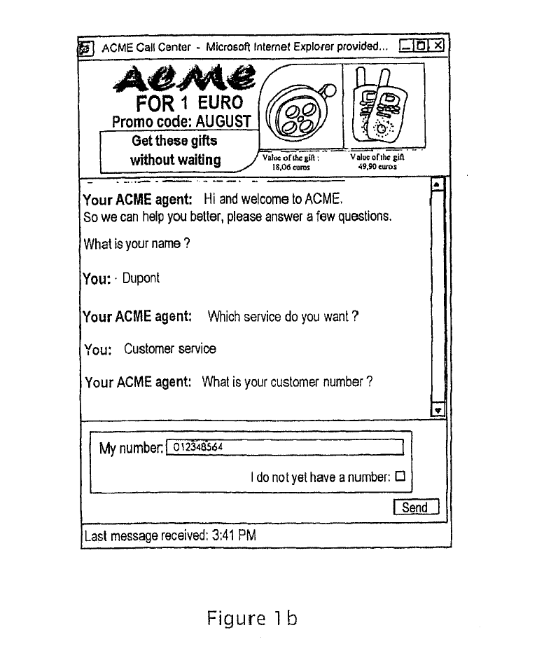

Other features and advantages of the invention become apparent in the course of the following description of various embodiments given with reference to the appended drawing, which shows one form of display on a terminal when its instant messaging application has received a message (FIG. 1a) and when the instant messaging application has sent a response to that message and has received another question (FIG. 1b).

### DETAILED DESCRIPTION OF THE INVENTION

An implementation of a method of the invention for communication between a first terminal of a call center and a second terminal of a client is described below with reference to the figures. In this application, the first exchanges between the client and the call center are effected conventionally without intervention of an agent. Consequently, the first terminal is not necessarily a physical device, and can be an application. However, in the context of describing the invention, the application is referred to as a terminal because it can send and receive, although without managing the display.

These terminals can be integrated into a communications network, for example a mobile or cable telecommunications network, or into an Internet type network. This is known in the art. However, the invention is in no way limited to any particular mode of communication or to any specific application for communication between terminals.

The method provides for the terminals to communicate via an instant messaging (IM) application. An IM application enables written communication between terminals interconnected by a network. To this end, an IM application provides for editing messages in one or more windows, sending messages to one or more other terminals, and displaying messages received from one or more other terminals. The use of IM applications to communicate is highly successful, in particular because they are very easy to use and user friendly.

In particular, the method enables communication of a questionnaire between terminals via the IM application. The use of a questionnaire is advantageous in the context of the calls envisaged here because it limits the number of possible responses, which helps to make the service provided by the call center dependable. In particular, the questionnaire can be of the closed type, i.e. it can allow only selection of one of the responses shown in the questionnaire.

To enable communication of a questionnaire via the IM application, the invention teaches that the IM application of the first terminal should code a message containing said questionnaire.

In one implementation, the message is coded in HTML. However, other languages can be used to display a questionnaire, in particular a questionnaire for limiting responses to a number of options. such other languages include ASP, JSP, ActivX, Javascript, and PHP. The manner in which the questionnaire is written is not limiting on the invention, since it depends on the language used.

There follows an example of a message coded in HTML by the IM application, which sends said message over a network using the Session Initiation Protocol (SIP).

01 - MESSAGE sip:client@myisp.com SIP/2.0
02 - Max-Forwards: 70
03 - From: sip:iimr3@acme.com;tag=49583
04 - To: sip:client@myisp.com;tag=1928301774
05 - Call-ID: asd88asd77a@1.2.3.4
06 - CSeq: 12 MESSAGE
07 - Content-Type: text/html
08 - Content-Length: 462
09 -
10 - <!DOCTYPE HTML PUBLIC “-//W3C//DTD HTML 3.2
Final//FR”>
11 - <html>
12 - <head>
13 - <title>ACME Corporation</title>
14- <meta http-equiv=“Content-Type” content=“text/html;
charset=iso-8859-1”>
15 - </head>
16 -
17 - <body>
18 - <p>Which service do you want to contact ?</p>
19 - <form name=“SelectService” method=“sip” action=
“sip:iimr3@acme.com”>
20 - <p>
21 - <label>
22 - <input type=“radio” name=“Service” value=“1”>
23 - Customer service</label>
24 - <br>
25 - <label>
26 - <input type=“radio” name=“Service” value=“2”>
27 - After-Sales service</label>
28 - </p>
29 - </form>
30 - </body>
31 - </html>

Lines 01 to 09 contain the SIP description of a standard IM message. By inserting specific wording into the message, line 07 tells the IM application receiving this message that the text portion of the message is not standard text but in the HTML format. Lines 10 to 31 are written in HTML to enable display of the questionnaire in the form specified in line 19. Moreover, line 19 specifies the URL address to which the message must be sent.

After the coded message has been sent from the first terminal to the second terminal, the IM application of the second terminal decodes the message to generate the questionnaire using an HTML translator. The IM application can then display the questionnaire, as shown in FIG. 1a.

As shown in that figure, the IM application of the second terminal generates a display window and a text entry window of a kind familiar to IM application users. A question “Which service do you want?” is placed in the display window while the possible responses “Customer Service” and “After-Sales Service” can be checked in the text entry window. An alternative that is not shown is to provide other forms of questionnaire, including questionnaires enabling a response by composing a portion of free text in the text entry window.

In an implementation of the method the IM application of the second terminal codes the response to the questionnaire, which is communicated to the first terminal and decoded by its IM application in a similar manner to that described above.

There follows an example of a coded message including the response to the questionnaire shown in FIG. 1a.

01 - MESSAGE sip:iimr3@acme.com SIP/2.0
02 - Max-Forwards: 70
03 - From: sip:client@myisp.com;tag=1928301774
04 - To: sip:iimr3@acme.com;tag=49583
05 - Call-ID: asd88asd77a@1.2.3.4
06 - CSeq: 13 MESSAGE
07 - Content-Type: application/x-www-form-urlencoded
08 - Content-Length: 18
09 -
10 - Service=1

Lines 01 to 09 contain the SIP description of a standard IM message. Line 07 tells the IM application receiving this message that the text portion of the message is not standard text but in the HTML format. Line 10 contains the HTML format response to the questionnaire: “Customer Service”.

Alternatively, the invention provides a communication method in which another terminal is connected to the IM application, the second terminal coding the response to the questionnaire so that it contains information relating to the terminal to which the response must be sent. This method therefore enables the IM application to send the coded message to the terminal concerned.

FIG. 1b represents the display on the second terminal when the method provides for sending it successive messages, the questionnaire in the coded message being generated as a function of the response to the questionnaire corresponding to the preceding coded message.

In FIG. 1b, the subsequent question is “What is your customer number?”. The text entry window includes a free field for entering the corresponding number and an area that can be checked to send an alternative response. Moreover, as shown in this figure, the method enables at least a portion of the response history to be displayed in the display window. In particular, the display can be in a standard text format familiar to IM application users. To this end, the method provides for using the title of the HTML link of the checked response.

A second aspect of the invention proposes an IM application that is installed in each of the terminals that are to communicate with each other to implement the method described above. To this end, the invention adapts an IM application so that it includes means for decoding received messages and means for coding sent messages. The coding means insert a questionnaire into an IM message and the decoding means generate the questionnaire from a coded message.

Furthermore, the coding means can code the response to a questionnaire and/or introduce a specific wording into the message, the decoding means interpreting said wording.

In an implementation, the coding means include in the message information in HTML, the decoding means interpreting the information in HTML to generate the questionnaire.

The invention as described above enables the use of a single communication application, with user friendly ergonomics and familiar to a large number of users. In particular, the user does not have to juggle a web application and a separate communication application. Furthermore, the invention retains the advantages of an IM application, in particular saving a call history and enabling each participant to consult the call history. Moreover, the simple way it involves other terminals in the call is also especially popular.

1. A method of communication between first and second terminals by means of an instant messaging (IM) application, said method comprising the following steps:
the IM application of the first terminal codes a message containing a questionnaire;
the first terminal sends said coded message to the second terminal;
the IM application of the second terminal decodes the message to generate the questionnaire corresponding to said coded message; and
the second terminal displays said questionnaire.

2. A communication method according to claim 1, wherein the response to the questionnaire is coded by the IM application of the second terminal and sent to the first terminal to be decoded by its IM application.

3. A communication method according to claim 1, wherein another terminal is connected to the IM application, the response to the questionnaire is coded by the second terminal so that it contains information relating to the terminal to which said response must be sent, and the IM application sends said response to the terminal concerned.

4. A communication method according to claim 2, wherein successive messages are sent to the second terminal and the questionnaire of the coded message is generated as a function of the response to the questionnaire corresponding to the preceding coded message.

5. A communication method according to claim 4, wherein at least a portion of the history of responses is displayed in a display window of the second terminal.

6. A communication method according to claim 1, wherein the questionnaire is of the closed type.

7. A communication method according to claim 1, wherein the questionnaire is displayed in a text entry window of the second terminal.

8. A communication method according to claim 1, wherein the message and/or the response are coded in HTML.

9. An instant messaging (IM) application including means for coding sent messages adapted to insert a questionnaire into a message and means for decoding received messages adapted to generate the questionnaire from a coded message.

10. An IM application according to claim 9, wherein the coding means code the response to a questionnaire.

11. An IM application according to claim 9, wherein the coding means insert a specific wording into the message and the decoding means interpret said wording.

12. An IM application according to claim 9, wherein the coding means insert information in HTML into the message and the decoding means interpret the information in HTML to generate the questionnaire.
